(19) United States
(12) Patent Application Publication
(10) Pub. No.: US 2008/0163855 A1
(43) Pub. Date: Jul. 10, 2008

(54) Methods systems and apparatuses of EGR control

(76) Inventors: Jeff Matthews, Columbus, IN (US); Ward Edwards, Columbus, IN (US); Vivek Sujan, Columbus, IN (US); Adrian Dale, Columbus, IN (US); Sam Geckler, Columbus, IN (US)

Correspondence Address: KRIEG DEVAULT LLP, ONE INDIANA SQUARE, SUITE 2800, INDIANAPOLIS, IN, 46204-2079, US

(21) Appl. No.: 12/002,517

(22) Filed: Dec. 17, 2007

Related U.S. Application Data
(60) Provisional application No. 60/876,777, filed on Dec. 22, 2006.

(51) Int. Cl. F02M 25/07; F02B 47/08; F02B 37/00

(52) U.S. Cl. 123/568.12; 60/605.2; 701/108

(57) ABSTRACT

One embodiment is a unique system for controlling EGR. Other embodiments include unique apparatuses, systems, devices, hardware, software, methods, and combinations of these and other techniques for controlling EGR.

### PRIORITY

The benefits and priority rights of U.S. Patent Application No. 60/876,777 filed Dec. 22, 2006 are claimed, and that application is incorporated by reference.

### BACKGROUND

Internal combustion engines such as diesel engines may be provided with exhaust gas recirculation (“EGR”) systems which recirculate exhaust to the engine intake as well as exhaust aftertreatment systems which can be used to reduce or eliminate emissions such as particulates, hydrocarbons (“HC”), carbon monoxide (“CO”), oxides of nitrogen (“NOx”), oxides of sulfur (“SOx”), hydrogen-sulfide (“H₂S”), and other emissions. EGR can aid in emissions control, for example, the mixing of recirculated exhaust gas and intake air can introduce dilutent effective to reduce combustion temperature, and reduce NOx formation and emissions. Under various operating conditions, for example, during engine startup, it may be desired to control EGR to facilitate engine operation compliant with a variety of conditions such as emissions, power output, torque output, horsepower output, and others.

### SUMMARY

One embodiment is a unique system for controlling EGR. Other embodiments include unique apparatuses, systems, devices, hardware, software, methods, and combinations of these and other techniques for controlling EGR. Further embodiments, forms, objects, features, advantages, aspects, and benefits of the present invention shall become apparent from the following illustrative description and drawings.

### BRIEF DESCRIPTION OF THE FIGURES

FIG. 1 is a schematic illustration of system including a diesel engine, EGR and exhaust aftertreatment.

FIG. 2 is a schematic illustration of a diesel engine and exhaust aftertreatment system.

FIG. 3 is a schematic illustration of a diesel engine and EGR system.

FIG. 4 is a schematic illustration of control logic.

### DETAILED DESCRIPTION

For the purposes of promoting an understanding of the principles of the invention, reference will now be made to the embodiments illustrated in the figures and specific language will be used to describe the same. It will nevertheless be understood that no limitation of the scope of the invention is thereby intended, such alterations and further modifications in the illustrated embodiments, and such further applications of the principles of the invention as illustrated therein being contemplated as would normally occur to one skilled in the art to which the invention relates.

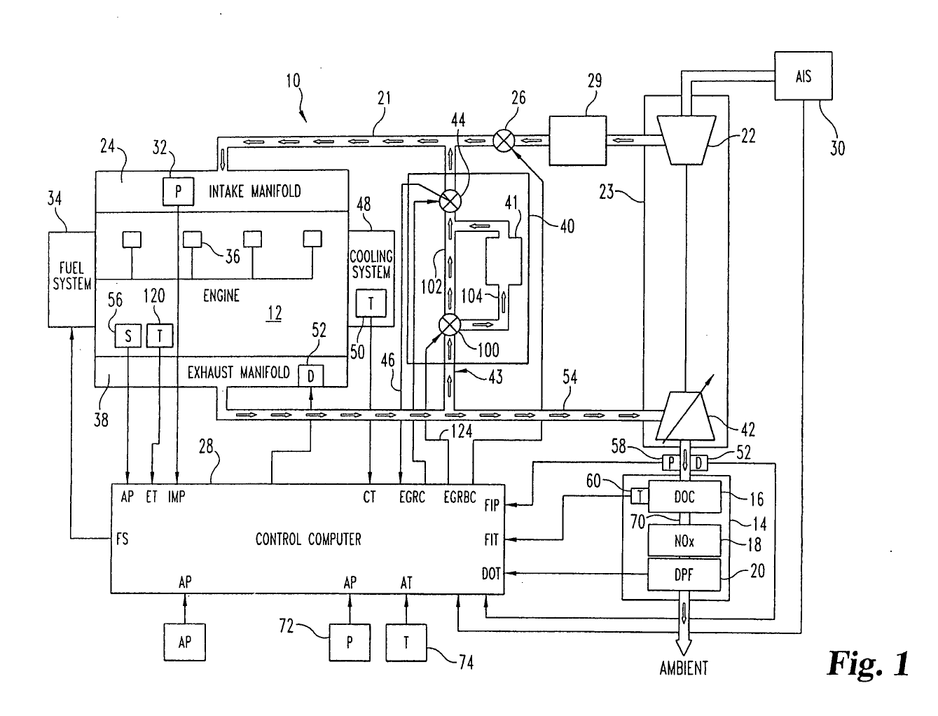

With reference to FIG. 1, there is illustrated system 10 which includes an internal combustion engine 12 operatively coupled with an exhaust aftertreatment system 14. Exhaust aftertreatment system 14 includes a diesel oxidation catalyst unit 16 which is preferably a close coupled catalyst but could be other types of catalyst units, an adsorber which is preferably a NOx adsorber or lean NOx trap 18 but could be other types of adsorbers or other NOx emissions control devices, and a diesel particulate filter 20. The exhaust aftertreatment system 14 is operable to remove unwanted pollutants from exhaust gas exiting the engine 12 after combustion.

The diesel oxidation catalyst unit 16 is preferably a flow through device that includes a canister that includes a honey-comb like structure or substrate. The substrate has a surface area that includes a catalyst. As exhaust gas from the engine 12 traverses the catalyst, CO, gaseous HC and liquid HC (unburned fuel and oil) are oxidized. As a result, pollutants may be converted to carbon dioxide and water.

NOx adsorber 18 is operable to adsorb NOx and SOx emitted from engine 12 to reduce their emission into the atmosphere. NOx adsorber 18 includes catalyst sites which catalyzes oxidation reactions and storage sites which store compounds. After NOx adsorber 18 reaches a certain storage capacity it may be regenerated through one or more processes described as deNOx and/or deSOx.

Diesel particulate filter 20 may include one or more of several types of particle filters. Diesel particulate filter 20 is utilized to capture unwanted diesel particulate matter from the flow of exhaust gas exiting the engine 12. Diesel particulate matter may include sub-micron size particles found in diesel exhaust, including both solid and liquid particles, as well as fractions such as inorganic carbon (soot), organic fraction (often referred to as SOF or VOF), and sulfate fraction (hydrated sulfuric acid). Diesel particulate filter 20 may be regenerated at regular intervals by combusting particulates collected in diesel particulate filter 20, for example, through temperature control achieved, for example, by control of EGR, fueling and/or turbocharger pressure boost.

During engine operation, ambient air is inducted from the atmosphere and is preferably compressed by a compressor 22 of a turbocharger 23 most preferably a variable geometry turbocharger before being supplied to the engine 12. The compressed air is supplied to the engine 12 through an intake manifold 24 that is connected with the engine 12. An air intake throttle valve 26 may be positioned between the compressor 22 and the engine 12 that is operable to control the amount of charge air that reaches the engine 12 from the compressor 22. The air intake throttle valve 26 may be connected with, and controlled by, an engine control unit (“ECU”) 28, but may be controlled by other controllers as well. The air intake throttle valve 26 is operable to control the amount of charge air entering the intake manifold 24 via the compressor 22.

An air intake sensor 30 is included either before or after the compressor 22 to monitor the amount of ambient air or charge air being supplied to the intake manifold 24. The air intake sensor 30 may be connected with the ECU 28 and may generate electric signals indicative of the amount or rate of air flow. An intake manifold pressure sensor 32 is connected with the intake manifold 24. The intake manifold pressure sensor 32 is operative to sense the amount of air pressure in the intake manifold 24, which is indicative of the amount of charge air flowing or provided to the engine 12. The intake manifold pressure sensor 32 is connected with the ECU 28 and generates electric signals indicative of the pressure value that are sent to the ECU 28.

The system 10 may also include a fuel injection system 34 such as a high pressure common rail fuel system that is connected with, and controlled by, the ECU 28. The fuel injection system 30 is preferably operable to deliver fuel into the cylinders of the engine 12, while precisely controlling the timing of the fuel injection, fuel atomization, the amount of fuel injected, the number and timing of injection pulses, as well as other parameters. In certain embodiments stratified injection modes may be used. In other embodiments homogeneous, partial homogeneous and/or mixed injection modes may be used. Fuel is injected into the cylinders of the engine 12 through one or more fuel injectors 36 and is combusted, preferably by compression, with charge air and/or EGR received from the intake manifold 24. Various types of fuel injection systems may be utilized in the present invention, including, but not limited to, pump-line-hozzle injection systems, unit injector and unit pump systems, common rail fuel injection systems and others.

Exhaust gases produced in each cylinder during combustion leave the engine 12 through an exhaust manifold 38 connected with the engine 12. A portion of the exhaust gas is communicated to an exhaust gas recirculation (“EGR”) system 40 and a portion of the exhaust gas is supplied to a turbine 42. The turbocharger 23 is preferably a single variable geometry turbocharger 23, but other types and/or numbers of turbochargers may be utilized as well. The EGR system 34 may be used to cool down the combustion process by providing a selectable amount of exhaust gas to the charge air being supplied by the compressor 22. Cooling combustion may reduce the amount of NOx produced during combustion. One or more liquid, charge air, and/or other types of EGR coolers 41 may be included to further cool the exhaust gas before being supplied to the air intake manifold 22 in combination with the compressed air passing through the air intake throttle valve 26. Furthermore, it is contemplated that high pressure loop EGR systems, low pressure loop EGR systems, and variations thereof could be used.

EGR system 40 includes an EGR valve 44 in fluid communication with the outlet of the exhaust manifold 38 and the air intake manifold 24. EGR valve 44 may also be connected to ECU 28, which is capable of selectively opening and closing EGR valve 44. EGR valve 44 may also have an associated differential pressure sensor that is operable to sense a pressure change, or delta pressure, across EGR valve 44. A pressure signal 46 may also be sent to ECU 44 indicative of the change in pressure across EGR valve 44. An air intake throttle valve 26 and EGR system 40, in conjunction with fuel injection system 34, may be controlled to run engine 12 in a rich mode or in a lean mode.

The portion of the exhaust gas not communicated to the EGR system 40 is communicated to turbine 42 of a turbocharger, which is driven by gases flowing through the turbine 42. Turbine 42 is connected to compressor 22 and provides driving force for compressor 22 which generates charge air supplied to the air intake manifold 24. As exhaust gas leaves turbine 42, it is directed to exhaust aftertreatment system 14, where it is treated before exiting the system 10.

A cooling system 48 may be connected with the engine 12. The cooling system 48 is preferably a liquid cooling system that transfers heat out of the block and other internal components of the engine 12. The cooling system 48 includes a water pump, radiator or heat exchanger, water jacket (including coolant passages in the block and heads), and a thermostat which is operable to control the flow of coolant through the engine and through a radiator or by pass flow path. A coolant temperature sensor 50 is operable to generate a signal that is sent to ECU 28 indicative of the temperature of the coolant used to cool engine 12.

System 10 may include a doser 52 which may be located in the exhaust manifold 38 and/or located downstream of the exhaust manifold 38. Doser 52 may comprise an injector mounted in an exhaust conduit 54. For the illustrated embodiment, reductant or reducing agent introduced through the doser 52 is diesel fuel; however, other embodiments are contemplated in which one or more different reductant are used in addition to or in lieu of diesel fuel. Additionally, reductant could occur at a different location from that illustrated. Doser 52 is in fluid communication with a fuel line coupled to a source of fuel or other reductant (not shown) and is also connected with the ECU 28, which controls operation of the doser 52. Other embodiments omit or do not utilize a doser. For example, a preferred embodiment utilizes in-cylinder dosing where the timing and amount of fuel injected into the engine cylinders by fuel injectors is controlled in such a manner that engine 12 produces exhaust including a controlled amount of un-combusted (or incompletely combusted) fuel. Further embodiments may use a combination of in-cylinder dosing and dosing from a doser.

System 10 also includes a number of sensors and sensing systems for providing ECU 28 with information relating to system 10. An engine speed sensor 56 may be included in or associated with engine 12 and is connected with ECU 28. Engine speed sensor 56 is operable to produce an engine speed signal indicative of engine rotation speed (“RPM”) that is provided to ECU 28. A pressure sensor 58 may be connected with the exhaust conduit 54 for measuring the pressure of the exhaust before it enters the exhaust aftertreatment system 14. Pressure sensor 58 may be connected with ECU 28. If pressure becomes too high, this may indicate that a problem exists with the exhaust aftertreatment system 14, which may be communicated to ECU 28.

At least one temperature sensor 60 may be connected with the diesel oxidation catalyst unit 16 for measuring the temperature of the exhaust gas as it enters the diesel oxidation catalyst unit 16. In other embodiments, two temperature sensors may be used, one at the entrance or upstream from the diesel oxidation catalyst unit 16 and another at the exit or downstream from the diesel oxidation catalyst unit 16 or at other locations. These temperature sensors are used to calculate the temperature of the diesel oxidation catalyst unit 16. In one embodiment, an average temperature may be determined, using an algorithm, from the two respective temperature readings of the temperature sensors 60 to arrive at an operating temperature of the diesel oxidation catalyst unit 16.

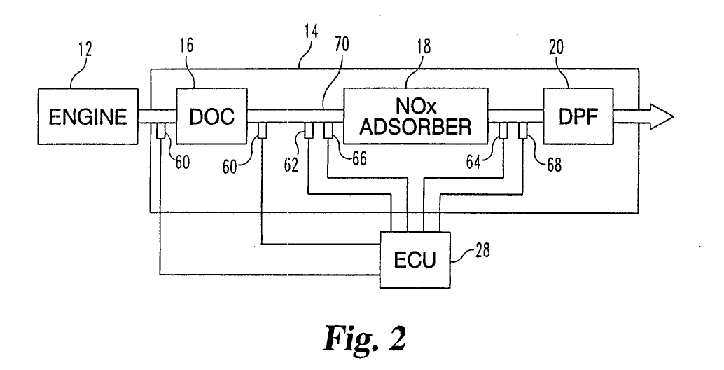

Referring to FIG. 2, a schematic diagram of exemplary exhaust aftertreatment system 14 is depicted connected in fluid communication with the flow of exhaust leaving the engine 12. A first NOx temperature sensor 62 may be in fluid communication with the flow of exhaust gas before entering or upstream of the NOx adsorber 18 and is connected to ECU 28. A second NOx temperature sensor 64 may be in fluid communication with the flow of exhaust gas exiting or downstream of the NOx adsorber 18 and is also connected to ECU 28. NOx temperature sensors 62, 64 are used to monitor the temperature of the flow of gas entering and exiting NOx adsorber 18 and provide electric signals to ECU 28 which are indicative of the temperature of the flow of exhaust gas. An algorithm may then be used by ECU 28 to determine the operating temperature of NOx adsorber 18.

A first universal exhaust gas oxygen (“UEGO”) sensor or lambda sensor 66 may be positioned in fluid communication with the flow of exhaust gas entering or upstream from NOx adsorber 18 and a second UEGO sensor or lambda sensor 68 may be positioned in fluid communication with the flow of exhaust gas exiting or downstream of NOx adsorber 18. Sensors 66, 68 are connected with ECU 28 and generate electric signals that are indicative of the amount of oxygen contained in the flow of exhaust gas. Sensors 66, 68 allow ECU 28 to accurately monitor air-fuel ratios (“AFR”) also over a wide range thereby allowing ECU 28 to determine a lambda value associated with the exhaust gas entering and exiting NOx adsorber 18.

Referring back to FIG. 1, an ambient pressure sensor 72 and an ambient temperature sensor 74 may be connected with ECU 28. Ambient pressure sensor 72 is utilized to obtain an atmospheric pressure reading that is provided to ECU 28. As elevation increases, there are fewer and fewer air molecules. Therefore, atmospheric pressure decreases with increasing altitude at a decreasing rate. Ambient temperature sensor 74 is utilized to provide ECU 28 with a reading indicative of the outside temperature or ambient temperature. As set forth in greater detail below, when engine 12 is operating outside of calibrated ambient conditions (i.e.—above or below sea level and at ambient temperatures outside of approximately 60-80° F.) the present invention may utilize a closed-loop control module to maintain the bed temperature of NOx adsorber 18 at the preferred regeneration temperature value (e.g. −650° C.).

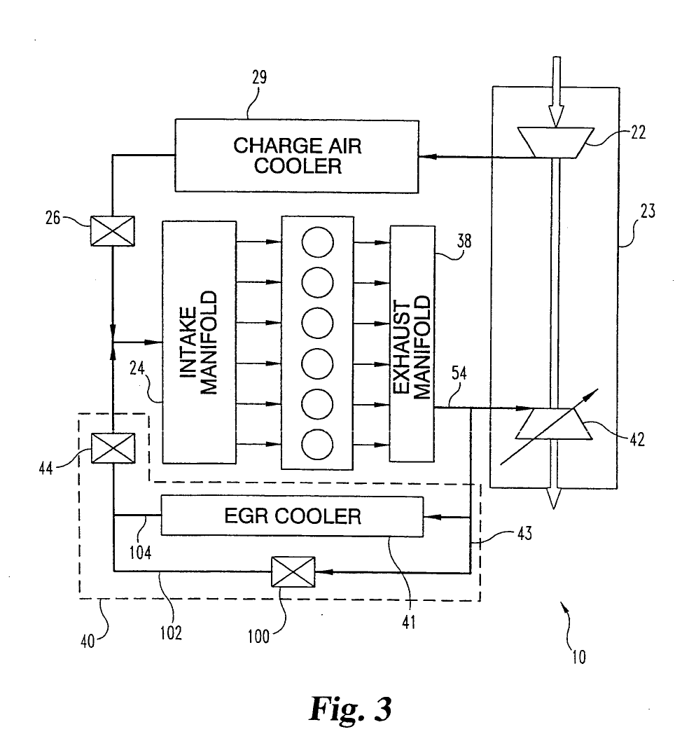

Referring to FIG. 3, an additional schematic of the system 10 is illustrated. The EGR system 40 includes the EGR valve 44 and the EGR cooler 41. The EGR system 40 further includes an EGR cooler bypass valve 100 coupled to the EGR conduit 43 and flow coupled with an EGR cooler bypass conduit 102. The EGR cooler 41 is flow coupled with an EGR cooler conduit 104. The EGR cooler bypass valve 100 can be selectably positioned in a bypass or opened position, and a cooler or closed position. When the EGR cooler bypass valve 100 is in the bypass position some or all of the exhaust gas flowing through the EGR conduit 43 flows through the EGR cooler bypass conduit 103. When the EGR cooler bypass valve 100 is in the cooler position all of the exhaust gas flowing through the EGR conduit 43 flows through the EGR cooler 41 to further cool the exhaust gas before being supplied to the air intake manifold 24 in combination with the compressed air passing through the air intake throttle valve 26. In one embodiment, the EGR valve 44 is positioned downstream of both the EGR cooler conduit 104 and the EGR cooler bypass conduit 102. In another embodiment, the EGR valve 44 is positioned upstream of both the EGR cooler conduit 104 and the EGR cooler bypass conduit 102. In one embodiment of the present application, the EGR cooler bypass valve 100 is positionable in a mixed or partially opened position allowing at least a portion of the exhaust gas to flow through each of the EGR cooler bypass conduit 102 and the EGR cooler conduit 104.

Referring back to FIG. 1, at least one sensor 120 is connected with the engine 12 for measuring the temperature of intake or charge air of the engine 12. In some embodiments sensor 120 may be an intake manifold temperature sensor. In some embodiments, sensor 120 may be a virtual intake manifold temperature sensor. In some embodiments sensor 120 may measure or virtually measure in cylinder temperature. In some embodiments sensor 120 may be upstream of intake manifold 24, In further embodiments, two or more temperature sensors 120 may be used. The intake charge air temperature is sent from sensor 120 along with the coolant temperature from coolant temperature sensor 50 to the ECU 28. In further embodiments, the location of the temperature measurement can be different or a virtual or estimated temperature can be used. As described in detailed below, the coolant and intake charge air temperatures are used by the ECU 28 in control of the EGR bypass valve 100.

Preferred embodiments contemplate NOx emissions control during the ensuing warm-up of the engine 12 from a cold start. A cold start typically means the engine 12 is started after achieving a soak temperature of approximately 70 degrees F. NOx emissions can be at least partially controlled by mixing exhaust gas with charge air from the compressor 22 in order to decrease the concentration of oxygen in the engine 12. The end result is lower NOx emissions due to lower combustion temperatures. However, by reducing the concentration of oxygen in cylinders in the engine 12, the likelihood of an engine misfire increases, particularly when the engine 12 is cold. Misfires may result when the charge oxygen concentration is insufficient (not enough ambient air) and/or when the charge temperature is too low to initiate or sustain combustion. To maximize the reduction of oxygen concentration while still avoiding misfire due to the engine being cold, the EGR cooler bypass valve 100 is operated in the bypass position. As discussed above, the exhaust gas in the EGR conduit 43 is routed around the EGR cooler 41 through the EGR cooler bypass conduit 102 when the EGR cooler bypass valve 100 is in the bypass position. By bypassing the EGR cooler 41, the exhaust gas increases the charge temperature due to the mixing of uncooled recirculated exhaust gas, thus reducing the risk of an engine misfire. Once the engine reaches a predetermined state or condition, the EGR cooler bypass valve 100 returns to the cooler position and the recirculated exhaust gas passes through the EGR cooler 41. The EGR valve bypass valve 100 is operably coupled to the ECU 28 to receive an operation signal 124 to move between the bypass position and the cooler position based on the predetermined state or condition. In one embodiment, the predetermined state is a combination of the intake charge air and the engine coolant temperatures. In another embodiment, the predetermined state includes only one of the coolant temperature and the intake charge air temperature. In one embodiment, the predetermined state includes a coolant temperature of about 120 degrees F. and an intake charge air temperature of about 140 degrees F. In another embodiment, the predetermined state includes a coolant temperature and an intake charge air temperature both at about 160 degrees F. The values provided for the intake charge air temperature and coolant temperature are exemplary values and the predetermined state maybe set based on desired operating conditions and it is within the scope of the present invention to include various temperature ranges for each of the intake charge air and the coolant temperatures.

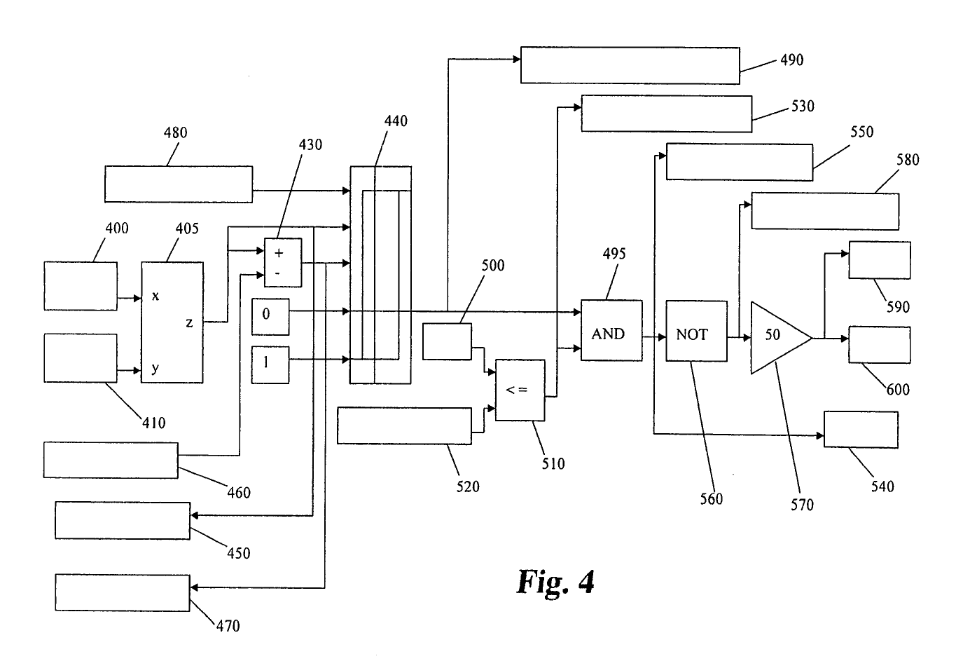

With reference to FIG. 4, there is illustrated a diagram of control logic operable to control the EGR cooler bypass valve such as EGR cooler bypass valve 100. Variable 400 (the Engine_Speed variable) is provided to the x input of a lookup table 405. Variable 400 is a function of engine speed and may be determined from a sensor such as engine speed sensor 56. Variable 410 (the Total_Fueling variable) is provided to the y input of lookup table 405. Variable 410 is a function of total fueling and may be determined by a sensor such as a virtual fueling sensor. Lookup table 405 outputs an intake manifold temperature high threshold based upon the inputs it receives. The output of lookup table 405 is provided to variable 450 (the H_ECBC_IMT_High_Threshold variable), which is a high threshold for intake manifold temperature, to the +input of operator 430, and to operator 440. Variable 460 is provided to the −input of operator 430. Variable 460, (the C_ECBC_IMT_HiToLow_Delta variable), is a delta or difference between the high threshold value of the intake manifold temperature and the low threshold value of the intake manifold temperature. Operator 430 subtracts the value of its bottom input from the value of its top input and outputs the result to operator 440 and to variable 470 (the H_ECBC_IMT_Low_Threshold variable) which is a low threshold for intake manifold temperature. Variable 480 (the IMT variable) is also input into the operator 440. Variable 480 is a function of intake manifold temperature and in one embodiment is determined from a signal from the sensor 120.

Operator 440 determines whether intake manifold temperature is within the high intake manifold temperature threshold and the low intake manifold temperature threshold and outputs to operator 495 and to variable 490 (the H_ECBC_Position_Crnd_Cond1 variable). Variable 500 is provided to the top input of an operator 510. Variable 500 is a function of coolant temperature, which can be determined based upon a signal from a sensor such as coolant temperature sensor 50. Variable 520 is provided to the lower input of operator 510. Variable 520 (the C_ECBC_Warmup_Collant_Tmptr variable) is a warm-up coolant temperature threshold or set point. Operator 510 determines if variable 500 is greater than or equal to variable 520 and outputs to operator 495 and to variable 530 (the H_ECBC_Position_CMD_Cond2 variable). Variable 490 is a first command condition variable and variable 530 is a second command condition variable.

Operator 495 is a Boolean AND operator which outputs to variable 550 (the H_ECBC_Position_CMD variable), variable 540 (the ECBC_Position_State variable), and to operator 560 which is a Boolean NOT operator. Operator 560 outputs to variable 580 (the H_ECBC_Position_Cmd_Inv variable). Variable 580 is input into amplifier 570 which provides an amplified output to variable 590 and a variable 600. In one embodiment, the amplifier 570 multiplies its input by fifty to drive current through the actuator of the cooler bypass valve 100. Variable 590 is the H_ECBC_HB_Abs_DC variable and the signal 600 is the hb_{—}0_duty_cycle variable.

In one embodiment, a controller, such as ECU 28, commands or controls cooler bypass valve 100 in the opened or bypass position based upon the value of variable 540. If variable 540 is a “1” (or on) the bypass mode is active and the cooler bypass valve 100 is open. If variable 540 is a “0” (or off) the bypass mode is inactive and the cooler bypass valve 100 is closed. In other embodiments, a controller, such as ECU 28, may sets cooler bypass valve 100 in the closed position based upon the value of variable 540. In further embodiments, a controller may also close the bypass valve 100 (or may close an EGR valve) when the Variable 480 (the IMT variable) exceeds a maximum threshold, such as variable 450 (the H_ECBC_IMT_High_Threshold variable), either in conjunction with or independent of coolant temperature.

While the invention has been illustrated and described in detail in the drawings and foregoing description, the same is to be considered as illustrative and not restrictive in character, it being understood that only the preferred embodiments have been shown and described and that all changes and modifications that come within the spirit of the inventions are desired to be protected. It should be understood that while the use of words such as preferable, preferably, preferred or more preferred utilized in the description above indicate that the feature so described may be more desirable, it nonetheless may not be necessary and embodiments lacking the same may be contemplated as within the scope of the invention, the scope being defined by the claims that follow. In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary.

What is claimed is:

1. A system comprising:
a passageway configured to route a flow of exhaust gas toward a cooler the cooler being flow coupled with the passageway and operable to transfer heat from the flow of exhaust gas to a coolant in flow communication with the cooler;
a bypass passageway flow coupled with the passageway and bypassing the cooler; and
a controller operable to control the flow of exhaust gas to the bypass passageway during exhaust gas recirculation based upon an intake temperature condition and a coolant temperature condition.

2. The system of claim 1 further comprising a EGR valve operable to control the flow of exhaust gas to an intake manifold.

3. The system of claim 2 further comprising a bypass valve operable to control the flow of exhaust gas through the bypass passageway.

4. The system of claim 3 wherein the EGR valve is positioned at a location downstream from the bypass valve.

5. The system of claim 3 wherein during exhaust gas recirculation the controller controls the bypass valve to obstruct the flow of exhaust through the bypass passageway when the engine coolant temperature condition indicates that a coolant temperature has met a coolant temperature threshold and the engine intake temperature condition indicates that the intake temperature has met an intake temperature threshold.

6. The system of claim 3 wherein the controller is operable to send an exhaust gas recirculation signal to the EGR valve to control the rate of exhaust gas recirculation.

7. The system of claim 3 wherein during exhaust gas recirculation the controller controls the bypass valve to close the flow of exhaust through the bypass passageway when an intake temperature is greater than a first threshold or a coolant temperature is greater than a second threshold.

8. The system of claim 3 further comprising a turbocharger having a compressor and a turbine, the compressor having an inlet and an outlet, the outlet being flow coupled to the intake manifold to deliver compressed charge air to the intake manifold.

9. The system of claim 8 further comprising a charge air cooler operably coupled to the intake manifold and the compressor outlet;
wherein the charge air cooler cools the compressed charge air from the compressor and delivers the cooled charge air to the intake manifold.

10. The system of claim 1 wherein the intake temperature condition is based upon an intake an manifold temperature information and the coolant temperature condition is based upon a coolant temperature information.

11. The system of claim 1 wherein the intake temperature condition is based upon information received from a intake manifold temperature sensor.

12. A method comprising:
delivering charge air to an intake manifold coupled to an engine;
sensing an intake manifold temperature;
sensing a coolant temperature;
recirculating at least a portion of exhaust gas generated by the engine; and
adjusting an EGR cooler bypass based upon the intake temperature and the coolant temperature.

13. The method of claim 12 wherein the adjusting includes opening an EGR cooler bypass valve allowing exhaust gas to bypass the EGR cooler when the intake manifold temperature is below a first temperature and the coolant temperature is below a second temperature.

14. The method of claim 13 wherein the adjusting further includes closing the EGR cooler bypass valve when at least one of the intake manifold temperature reaches the first temperature and the coolant temperature reaches the second temperature.

15. The method of claim 12 wherein the adjusting includes closing the EGR cooler bypass valve when the intake manifold temperature reaches the first temperature and the coolant temperature reaches the second temperature.

16. The method of claim 12 further comprising cooling the charge air prior to delivering the charge air to the intake manifold.

17. The method of claim 12 further comprising adjusting an EGR valve to vary the amount of flow of exhaust gas into the intake manifold.

18. A computer readable medium configured to store instructions to process an intake manifold temperature information and a coolant temperature information and adjust an EGR cooler bypass valve based upon the intake manifold temperature information and the coolant temperature information.

19. The computer readable medium of claim 17 wherein the instructions are operable to open an EGR cooler bypass valve when the intake manifold temperature is below a first temperature and the coolant temperature is below a second temperature, and close the EGR cooler bypass valve when at least one of the intake manifold temperature reaches the first temperature and the coolant temperature reaches the second temperature.

20. The computer readable medium of claim 18 wherein the instructions are operable to close the EGR cooler bypass valve when the intake manifold temperature reaches the first temperature and the coolant temperature reaches the second temperature.
